(19) United States
(12) Patent Application Publication
(10) Pub. No.: US 2023/0013147 A1
(43) Pub. Date: Jan. 19, 2023

(54) COMPACT ELECTRICAL CONNECTOR

(71) Applicant: Amphenol East Asia Ltd., Taoyuan City (TW)

(72) Inventor: Lo-Wen (a.k.a Joan) Lu, Taoyuan City (TW)

(73) Assignee: Amphenol East Asia Ltd., Taoyuan City (TW)

(21) Appl. No.: 17/867,067

(22) Filed: Jul. 18, 2022

Related U.S. Application Data
(60) Provisional application No. 63/223,183, filed on Jul. 19, 2021.

(51) Int. Cl. H01R 12/70; H01R 12/77; H01R 13/08

(52) U.S. Cl. CPC H01R 12/7023; H01R 12/777; H01R 13/08

(57) ABSTRACT

A receptacle connector includes a metal housing configured to prevent backwards insertion of a plug. The receptacle connector has walls bounding an assembly space with an insulative body therein. One wall is distant from an exterior surface of the insulative body to form an abutting groove between the metal housing and the insulative body. The abutting groove is configured to receive an abutting wall of the plug connector. The insulative body includes mating interface configured to receive a terminal portion of a plug connector. A wall of the metal housing opposite the abutting groove is adjacent a surface of the insulative body has a projection. If a user attempts to insert the plug with the terminal portion backwards, the projection interferes with the abutting wall, preventing backwards insertion of the terminal portion of the plug into the mating interface.

### CROSS-REFERENCE TO RELATED APPLICATIONS

The present application claims the benefit of priority of U.S. Provisional Application No. 63/223,183 filed Jul. 19, 2021, entitled “COMPACT ELECTRICAL CONNECTOR,” the entire contents of which is incorporated by reference herein.

### FIELD OF THE INVENTION

The present invention relates generally to electrical interconnection systems. More specifically, the present invention relates to compact electrical connectors.

### BACKGROUND

Electrical connectors are used in many electronic systems. In general, many different types of electronic devices (e.g., smart phones, tablet computers, desktop computers, notebook computers, and digital cameras, and the like) have been provided with various types of electrical connectors so that the electronic devices can exchange data with each other. Therefore, it can be seen that the connectors can be used for electrical connection and signal transmission between devices, between electrical components within each device, and between electrical systems comprised of, e.g., one or more electrical devices. Electrical connectors may be considered, in many respects, basic components needed to make a complete system.

It is generally easier and more cost-effective to manufacture a system as separate electronic assemblies, such as separate printed circuit boards (“PCBs”), which may be joined together with electrical connectors. In some scenarios, the PCBs to be joined together may have electrical connectors mounted to them, which may be mated to directly to interconnect the PCBs.

In other scenarios, the PCBs may be connected via a cable. Electrical connectors may nonetheless be used to make such connections. For example, the cable may be terminated at one or both ends with a plug connector. A PCB may be equipped with a receptacle connector into which the plug connector is inserted, to make an electrical connection between the PCB and the cable. A similar arrangement may be used at the other end of the cable, to connect the cable to another PCB, so that signals may pass between the PCBs through the cable.

Cables often are manufactured with desirable electrical properties to pass signals between electrical devices, components, and/or systems. These desirable electrical properties may include low attenuation and uniform impedance. It is often advantageous to maintain these desirable electrical properties through mated plug and receptacle connectors, so that a signal may travel a complete path between interconnected PCBs without significant impact on signal integrity. It is a challenge, however, to design a connector that provides these desirable electrical properties while meeting other requirements, such as occupying a small volume and/or providing reliable operation.

### SUMMARY

Disclosed herein is a connector that prevents backwards mating with another connector. The connector may be a receptacle connector with a metal housing configured to prevent backwards insertion of a plug connector. The receptacle connector may have walls bounding an assembly space, with an insulative body disposed in the assembly space. One wall may be distant from an exterior surface of the insulative body to form an abutting groove between the metal housing and the insulative body. The abutting groove may be configured to receive an abutting wall of the plug connector. The insulative body may include a mating interface configured to receive a terminal portion of a plug connector. A wall of the metal housing opposite the abutting groove is adjacent a surface of the insulative body and has a projection. If a user attempts to insert the plug connector with the terminal portion backwards, the projection of the metal housing interferes with the abutting wall of the plug connector, preventing backwards insertion of the terminal portion of the plug into the mating interface.

According to one aspect of the disclosed technology, a receptacle connector may be comprised of: a metal housing with first, second, third, and fourth walls bounding an assembly space; and an insulative body disposed in a portion of the assembly space and fixed to the metal housing. Opposite ends of the first wall of the metal housing may be attached to first ends of the second and third walls of the metal housing, respectively, and opposite ends of the fourth wall of the metal housing may be attached to second ends of the second and third walls of the metal housing, respectively. The first wall of the metal housing may be positioned at a distance from a corresponding first side face of the insulative body to form an abutting groove bounded by the first side face of the insulative body and internal surfaces of the first, second, and third walls of the metal housing. The fourth wall of the metal housing may be positioned adjacent a corresponding second side face of the insulative body. An external surface of the fourth wall of the metal housing may be comprised of a projection that extends outward from the external surface. The insulative body may be comprised of an accommodation space configured to receive a terminal portion of a plug connector when the plug connector is mated with the receptacle connector. The abutting groove may be configured to receive an abutting wall of the plug connector when the plug connector is mated with the receptacle connector. The projection of the metal housing may be configured such that the terminal portion of the plug connector may be insertable in the accommodation space of the insulative body when the plug connector is positioned in a first orientation and may not be insertable in the accommodation space when the plug connector is positioned in a second orientation reverse from the first orientation.

In some embodiments of this aspect, a perpendicular distance D1 from a centerline of the accommodation space of the insulative body to an outer surface of the projection of the metal housing may be greater than a perpendicular distance D2 from the centerline of the accommodation space of the insulative body to the first side face of the insulative body.

In some embodiments of this aspect, the projection of the metal housing may be comprised of a bent portion of the fourth wall of the metal housing. In some other embodiments of this aspect, the projection may be comprised of a structure fixedly attached to the external surface of the fourth wall.

In some embodiments of this aspect, a bottom portion of the abutting groove may limit an insertion depth of the abutting wall of the plug connector into the abutting groove when the plug connector is mated with the receptacle connector. In some implementations, the bottom portion of the abutting groove may be comprised of a bearing section of the metal housing. In some implementations, the bearing section may extend from a lower portion of the first wall of the metal housing.

In some embodiments of this aspect, a height of the first wall of the metal housing may be greater than a height of the fourth wall of the metal housing. In some embodiments, a height of the insulative body may be same as the height of the fourth wall of the metal housing. In some embodiments, a portion of each of the second and third walls of the metal housing may have a height same as the height of the first wall of the metal housing.

In some embodiments of this aspect, the first wall of the metal housing may be comprised of at least one snap-fit structure configured to latch with at least one corresponding snap-fit structure on the abutting wall of the plug connector when the plug connector is mated with the receptacle connector. In some embodiments, a height of the at least one snap-fit structure of the metal housing may be partially or wholly lower than a height of a top surface of the insulative body.

In some embodiments of this aspect, the accommodation space in the insulative body may be elongated in a width direction of the receptacle connector. A maximum width of the metal housing may be in a range of 6 mm to 8 mm.

In some embodiments of this aspect, the receptacle connector may be further comprised of a plurality of metal terminals embedded in the insulative body. The metal terminals may have upper ends exposed in the accommodation space and configured to contact the terminal portion of the plug connector when the plug connector is mated with the receptacle connector, and may have lower ends extending from a bottom side of the insulative body and configured for mounting to a PCB.

According to another aspect of the disclosed technology, a metal housing for a receptacle connector is provided. The metal housing may be comprised of: first, second, third, and fourth walls having internal surfaces that bound an assembly space, with the first wall being positioned between the second and third walls and connected to first ends of the second and third walls, and with the fourth wall being positioned between the second and third walls and connected to second ends of the second and third walls; a bearing section extending from a lower portion of the first wall, the bearing section being inclined at an angle relative to the first wall such that the bearing section and the first wall are not coplanar; and a projection extending outward from an external surface of the fourth wall.

In some embodiments of this aspect, the projection may be comprised of a bent portion of the fourth wall. In some other embodiments of this aspect, the projection may be comprised of a structure fixedly attached to the external surface of the fourth wall.

In some embodiments of this aspect, a height of the first wall may be greater than a height of the fourth wall. In some embodiments, a portion of each of the second and third walls may have a height same as the height of the first wall.

In some embodiments of this aspect, the assembly space may be configured to accommodate an insulative body such that: the first wall is positioned at a distance from a corresponding first side surface of the insulative body, the fourth wall is positioned adjacent a second side surface of the insulative body, an abutting groove is located in the assembly space and is bounded by the first side surface of the insulative body and the internal surfaces of the first, second, and third walls, and the bearing section forms a bottom surface of the abutting groove to limit a depth of the abutting groove. The abutting groove may be configured to receive an abutting wall of a plug connector when the plug connector is mated with the receptacle connector. In some embodiments, the first wall may be comprised of at least one snap-fit structure configured to latch with at least one corresponding snap-fit structure on the abutting wall of the plug connector when the plug connector is mated with the receptacle connector. In some embodiments, a height of the at least one snap-fit structure of the first wall metal housing may be partially or wholly lower than a height of the fourth wall.

In some embodiments of this aspect, the metal housing may be further comprised of: an inclined section extending from a lower portion of the fourth wall. The inclined section may be inclined at an acute angle relative to the fourth wall such that the inclined section and the fourth wall are not coplanar.

According to yet another aspect of the disclosed technology, a metal housing for a receptacle connector is provided. The metal housing may be comprised of: a first wall; a second wall that includes an external surface and an internal surface facing the first wall; and a projection extending outward from the external surface of the second wall.

In some embodiments of this aspect, the metal housing may further be comprised of: a bearing section extending from a lower portion of the first wall. The bearing section may be inclined at an angle relative to the first wall such that the bearing section and the first wall are not coplanar. In some embodiments, the projection may be comprised of a bent portion of the second wall. In some embodiments, the projection may be comprised of a structure fixedly attached to the external surface of the second wall. In some embodiments, a height of the first wall may be greater than a height of the second wall.

In some embodiments of this aspect, the metal housing may further be comprised of: a third wall positioned between the first and second walls; and a fourth wall being positioned between the first and second walls. Internal surfaces of the first, second, third, and fourth walls bound an assembly space configured to accommodate an insulative body therein.

In some embodiments of this aspect, a height of the first wall may be greater than a height of the second wall, and a portion of each of the third and fourth walls may have a height same as the height of the first wall.

In some embodiments of this aspect, the assembly space may be configured to accommodate the insulative body such that: the first wall may be positioned at a distance from a corresponding first side surface of the insulative body, the second wall may be positioned adjacent a second side surface of the insulative body, an abutting groove may be located in the assembly space and may be bounded by the first side surface of the insulative body and the internal surfaces of the first, third, and fourth walls, and the abutting groove may be configured to receive an abutting wall of a plug connector when the plug connector is mated with the receptacle connector.

In some embodiments of this aspect, the first wall may be comprised of at least one snap-fit structure configured to latch with at least one corresponding snap-fit structure on a plug connector, when the plug connector is mated with the receptacle connector. In some embodiments, a height of the at least one snap-fit structure of the first wall metal housing may be partially or wholly lower than a height of the second wall.

In some embodiments of this aspect, the metal housing may further be comprised of: an inclined section extending from a lower portion of the second wall. The inclined section may be inclined at an acute angle relative to the second wall such that the inclined section and the second wall are not coplanar.

The foregoing and other aspects, embodiments, and features of the present teachings may be more fully understood from the following description in conjunction with the accompanying drawings.

### BRIEF DESCRIPTION OF DRAWINGS

A skilled artisan will understand that the figures, described herein, are for illustration purposes only. It is to be understood that in some instances various aspects of the present invention may be shown exaggerated or enlarged to facilitate an understanding of the invention. In the drawings, like reference characters generally refer to like features, which may be functionally similar and/or structurally similar elements, throughout the various figures. The drawings are not necessarily to scale, as emphasis is instead placed on illustrating and teaching principles of the various aspects of the invention. The drawings are not intended to limit the scope of the present teachings in any way.

FIG. 1A is a top front perspective view of a receptacle connector, according to some embodiments of the present invention;

FIG. 1B is a top rear perspective view of the receptacle connector of FIG. 1A;

FIG. 2A is a top rear perspective view of the receptacle connector of FIG. 1A in a partially disassembled state;

FIG. 2B is a top front perspective view of the receptacle connector of FIG. 1A in a partially disassembled state;

FIGS. 3A and 3B show right-side and left-side elevational views, respectively, of the receptacle connector of FIG. 1A;

FIG. 4 is a top plan view of the receptacle connector of FIG. 1A;

FIGS. 5A and 5B are top front and top rear perspective views, respectively, of the receptacle connector of FIG. 1A aligned to mate with a plug connector, according to some embodiments of the present invention;

FIGS. 6A and 6B are top rear and top front perspective views, respectively, of a cross section of a housing of the receptacle connector of FIG. 1A, cut along line A-A in FIG. 4;

FIG. 7A is an elevational view of the cross section of the housing shown in FIGS. 5A and 5B; and

FIG. 7B is an elevational view of a cross section of the receptacle connector of FIG. 1A, cut along line A-A.

In the drawings, the following reference numbers are used:
1—receptacle connector;
11—insulative body;
11A—rear outer surface of insulative body;
11B—front outer surface of insulative body;
110—mating interface;
111—accommodation space;
112—recess;
114—terminal slot;
115—inclined support portion;
116—top surface;
117—latch portion;
13—terminal assembly;
13a—metal terminal;
13b—terminal bar;
15—metal housing;
15A—rear sidewall of housing;
15B—front sidewall of housing;
15C—left sidewall of housing;
15D—right sidewall of housing;
150—assembly space;
151—snap-fit structure;
152—projection on front sidewall of housing
153—abutting groove;
154—bearing part;
155—rear pin;
156—front pin;
157—inclined part;
158—latch portion;
2—plug (mating) connector;
21—terminal board;
22—cable opening;
23—abutting wall;
230—springy member;
231—snap-fit protrusion (projecting block);
232—release tab; and
θ—acute angle.

### DETAILED DESCRIPTION

The inventors have recognized and appreciated design techniques for reliable operation of miniaturized electrical connectors for high-integrity signal interconnections. According to various embodiments of the present invention, one or more design features are provided to prevent the occurrence of erroneous mating orientations that can result in damage to the electrical connectors and/or improper operation of an electronic device incorporating the connector. Those design features may be formed at low cost by positioning those features to cooperate with other features that provide compact yet robust connectors.

Some receptacle connectors, for example, may have design features that guide a mating plug connector in an intended insertion direction. There may be a lower risk of damage to the connector if, during a mating operation, force is applied in a direction parallel to an axial direction of the receptacle connector. However, in practice, a user may not be paying special attention to an entry angle or direction at which the plug connector is being inserted into the receptacle connector. Thus, the receptacle connector may be subjected to an external force that is not parallel to the axial direction (i.e., the proper entry direction), which may cause the receptacle connector to tilt relative to the PCB. To help a user press the plug connector to assert force in a direction parallel to the axial direction of the receptacle connector, a metal housing may surround an insulative body of the receptacle connector. A wall of the metal housing may be offset from the insulative body to create an abutting groove between the metal housing and the insulative body. The abutting groove may be sized to receive a projection, such as an abutting wall, from a plug connector. The abutting wall may engage with the wall of the metal housing, such that the wall of the metal housing guides the abutting wall into the abutting groove and, simultaneously, guide a paddle card of the plug connector into a mating interface of the receptacle connector in the direction parallel to the axial direction.

The inventors have recognized and appreciated that, despite these design features to orient the plug for insertion in the direction parallel to the axial direction, there is still a risk of misalignment of the plug and receptacle that may lead to damage or improper operation of the connector. A user, for example, may confuse a front side from a rear side of the receptacle connector and may inadvertently attempt to insert the plug in a “backwards” orientation, such that a rear side of the plug connector erroneously faces the front side of the receptacle connector. In such a situation, even if the user is careful to align the other connector so that there is no tilt relative to the receptacle connector (i.e., the applied mating force is in the proper axial direction), the backwards mated pair of connectors may not function to transmit signals as intended, which could lead to malfunction of the electrical device. The user may then unnecessarily spend time and resources to troubleshoot the malfunction and, in some cases, may discard the electrical device after erroneously concluding that the electrical device is broken. Additionally, in applying the mating force with the other connector oriented backwards, damage may occur to the receptacle connector and/or the other connector (e.g., a protrusion may wedge against a surface that is not configured to accommodate the protrusion). As will be appreciated, other types of damage may occur when a user erroneously mates or attempts to mate the other connector in a backwards orientation relative to the receptacle connector.

Techniques described herein may reduce or prevent the occurrence of damage due to mating forces being applied when a plug connector is misaligned (e.g., tilted) relative to the receptacle connector and can reduce or prevent the occurrence of erroneous mating operations where the plug connector is misoriented (e.g., backwards) relative to the receptacle connector.

In some embodiments of the present invention, the metal housing of the receptacle connector may have a projection configured to prevent backwards mating of the plug connector to the receptacle connector. The projection may facilitate situations where blind mating takes place. For example, the user may not be able to see that the plug connector is facing backwards relative to the receptacle connector and may attempt to erroneously mate these connectors in a reverse or backwards orientation. As discussed below, the projection may function to prevent a terminal board of the plug connector from being inserted in an accommodation space of the receptacle connector if the plug connector is backwards.

Examples of some embodiments of the present invention are provided below. Aspects and features of the foregoing techniques as well as aspects and features of other techniques described herein may be used alone or in any suitable combination. Some embodiments of the present invention may combine one or more features and/or aspects of one embodiment with one or more features and/or aspects of one or more other embodiments.

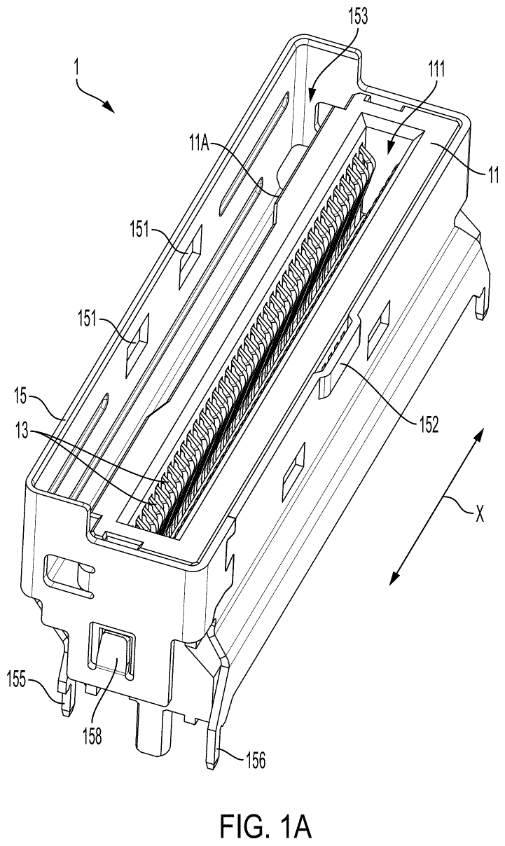

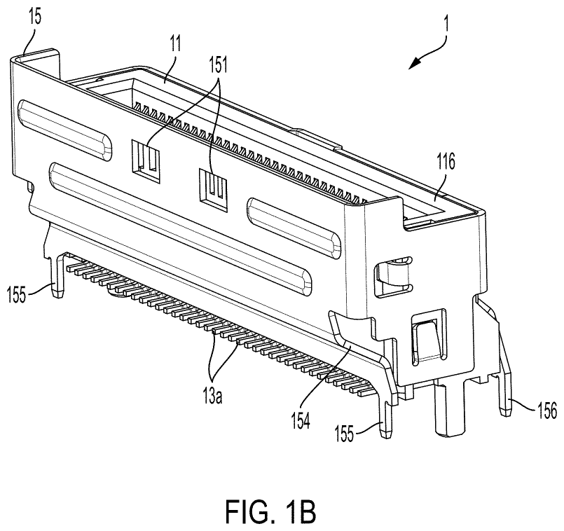

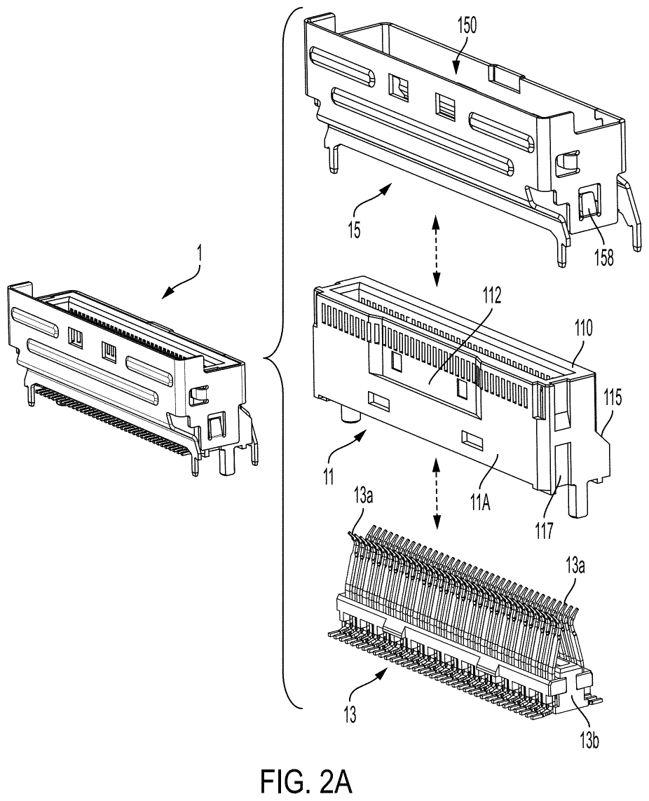

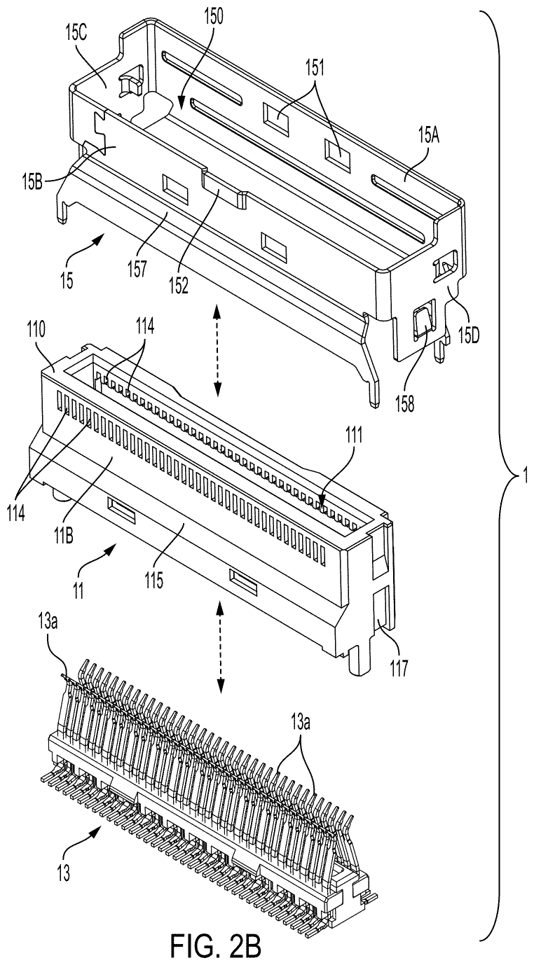

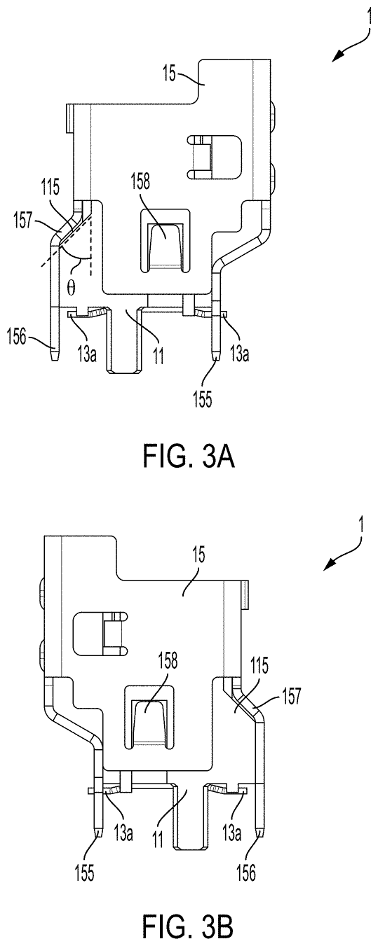

FIGS. 1A and 1B show front and rear perspective views of a receptacle connector 1, according to some embodiments of the present invention. FIGS. 2A and 2B show front and rear perspective views, respectively, of the connector 1 in a partially disassembled state. FIGS. 3A and 3B show right-side and left-side elevational views, respectively, of the connector 1. As shown in FIGS. 1A through 3B, the connector 1 may be comprised of an insulative body 11, a terminal assembly 13 comprised of a plurality of metal terminals 13a, and a metal housing 15. In some embodiments, the connector 1 may be configured to be mounted on a PCB by rear pins 155 and front pins 156 extending outward from a bottom portion of the connector 1. The pins 155, 156 may be used to attach the connector 1 to the PCB. As will be appreciated, other arrangements may be used to mount the connector 1 to the PCB.

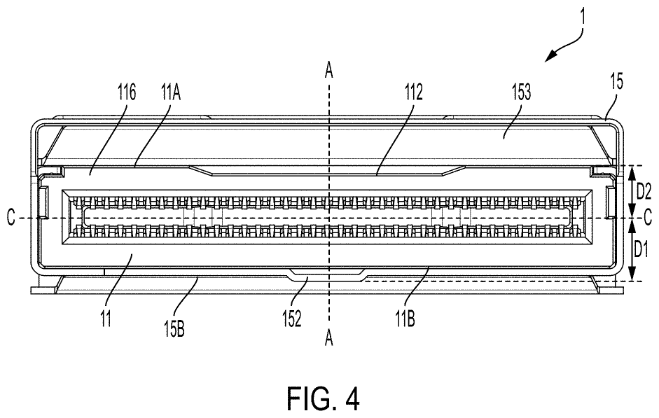

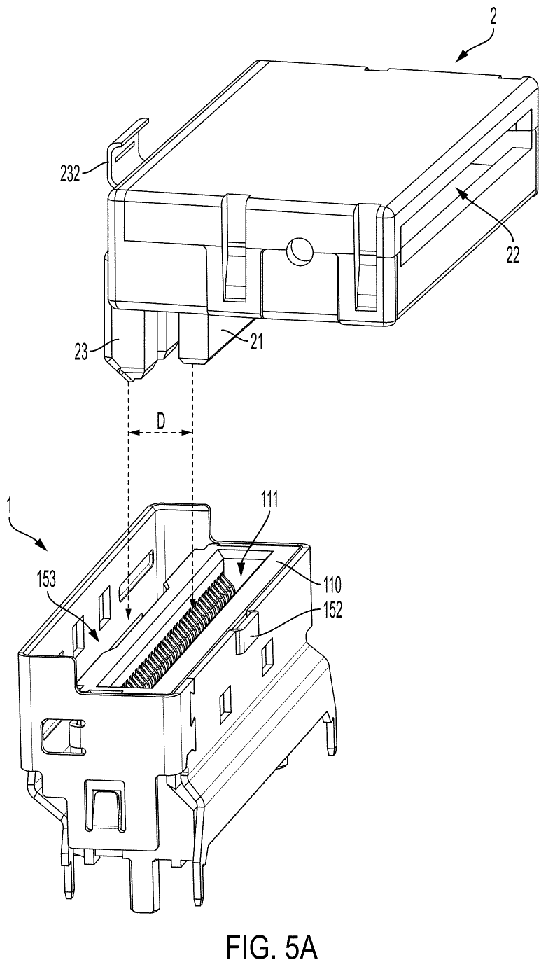

FIG. 4 shows a plan view of a top surface 116 of the connector 1, where the connector 1 faces another (mating) connector when the connector 1 and the mating connector are mated together. The top surface 116 of the connector 1 may include a mating interface 110 of the insulative body 11. The mating interface 110 may be shaped to mechanically receive a mating component (e.g., a paddle card, a terminal card, a leg, a protrusion, etc.) of the mating connector. In some embodiments of the present invention, the mating interface 110 may be comprised of an accommodation space 111, which may be a recessed portion of the mating interface 110. When the connector 1 and the mating connector are in a mated position, the mating component of the mating connector may fit within the accommodation space 111. For example, as depicted in FIGS. 5A and 5B, the mating connector may be a plug connector 2 configured to mate with the connector 1. The plug connector 2 may be comprised of a terminal board 21 configured to fit in the accommodation space 111 of the insulative body 11 when the connectors 1, 2 are mated together.

According to some embodiments of the present invention, the accommodation space 111 of the insulative body 11 may be bounded by two inner side surfaces that face each other. Each inner side surface of the accommodation space 111 may be provided with a plurality of terminal slots 114. In some embodiments, the terminals 13a of the connector 1 may be disposed in the accommodation space 111, and a portion of each terminal 13a may extend into a corresponding one of the terminal slots 114. The terminals 13a may be configured to make mechanical and electrical contact with the mating component of mating connector. For example, the terminals 13a may be configured to press against and electrically contact the terminal board 21 of the plug connector 2 when the terminal board 21 is inserted in the accommodation space 111 of the insulative body 11 of the connector 1. It should be understood, however, that the connector 1 may be configured in other ways to provide a mating interface to a mating connector. For example, in some embodiments, the insulative body 11 may have no terminal slots, or, in some other embodiments, the terminal slots 114 may be in an island or tongue plate disposed in the accommodation space 111 of the insulative body 11. As such, the connector 1 may have a structure other than what is specifically shown in the drawings and/or specifically described herein.

Referring to FIGS. 2A and 2B, the terminal assembly 13 may be disposed in the insulative body 11, and the terminals 13a may be respectively fixed to a terminal bar 13b of the terminal assembly 13 such that each terminal 13a may be separated from an adjacent terminal by a distance, according to some embodiments of the present invention. The terminals 13a may be comprised of different types (e.g., signal terminal, ground terminal, power terminal, etc.). Top ends of the terminals 13a may serve as mating contact portions and may be disposed in the accommodation space 111 such that an edge of the mating component of the mating connector may engage with and slide across the mating contact portions (i.e., the top ends of the terminals 13a) during insertion of the mating component into the accommodation space 111. For example, referring to FIGS. 5A and 5B, during mating of the plug connector 2 with the connector 1, an edge of the terminal board 21 may make contact with and slide across the mating contact portions of the terminals 13a to reach a mated position. Once mated, the terminals 13a may be electrically connected to terminals of the plug connector 2.

According to some embodiments of the present invention, the insulative body 11 may be comprised of at least one base support portion 115 configured to aid in stabilizing the connector 1 when mounting the connector 1 to a PCB. The support portion 115 may protrude outward from a front outer surface 11B of the insulative body 11 so that, when the insulative body 11 is mounted or being mounted to a PCB, a bottom face of the support portion 115 may abut against a top surface of the PCB to stabilize the connector 1 on the PCB. In some embodiments, the support portion 115 of the insulative body 11 may be inclined at an acute angle θ (FIG. 3A) relative to a vertical direction of the connector 1 and relative to the front outer surface 11B of the insulative body 11. The vertical direction may be the axial insertion direction of the plug connector 2 into the connector 1 in a mating operation. The housing 15 may be comprised of an inclined part 157, which may be inclined at the same acute angle θ, and which may be supported by an upper face of the support part 115, as depicted in FIGS. 3A and 3B. During assembly or use of the connector 1 (for example, when inserting the plug connector 2 into the connector 1), when the insulative body 11 is subjected to an applied force that is not aligned with its axial insertion direction (e.g., the direction of the dashed arrow in FIG. 5A), the support part 115 may support a bending load of the insulative body 11 caused by the applied force. For example, the bottom face of the support portion 115 may act to stabilize the insulative body 11 relative to the PCB during mating of the plug connector 2 with the connector 1, so as to prevent excessive force from being exerted in a direction misaligned with the axial insertion direction, thus preventing the terminals 13a from being dislodged from the PCB.

According to some embodiments of the present invention, the housing 15 may be formed by bending a metal plate into a frame shape configured to encircle or frame a portion of the insulative body 11. In some embodiments, the housing 15 may be comprised of rear, front, left, and right sidewalls 15A, 15B, 15C, 15D surrounding an assembly space 150, as depicted in FIG. 2B. The assembly space 150 may be configured to accommodate the insulative body 11 when the housing 15 and the insulative body 11 are assembled together in the connector 1. In some embodiments, the front sidewall 15B may directly face the front outer surface 11B of the insulative body 11 when the housing 15 and the insulative body 11 are assembled together, as shown in FIG. 1A. In some embodiments, the left and right sidewalls 15C, 15D may be comprised of latch portions 158 configured to engage with corresponding latch portions 117 of the insulative body 11 when the housing 15 and the insulative body 11 are assembled together. For example, the latch portions 117 of the insulative body 11 may be recesses, and the latch portions 158 of the housing 15 may be projections that extend inward to engage with the recesses, such that the insulative body 11 and the housing 15 may have a fixed position relative to each other when the housing 15 and the insulative body 11 are assembled together. In some embodiments, the metal of the housing 15 may prevent electromagnetic interference (EMI) by serving as a grounding route, and therefore may protect the insulative body 11.

According to some embodiments of the present invention, the housing 15 may form a portion of a latching structure that latches the connector 1 to a mating connector. In some embodiments, the housing 15 may be comprised of at least one snap-fit structure 151 on the rear sidewall 15A. Each snap-fit structure 151 may be configured to engage with a corresponding structure on the mating connector. In some embodiments, an example of which is shown in FIG. 5B, each snap-fit structure 151 may be a recess or hole configured to receive a corresponding snap-fit protrusion 231 of the plug connector 2 when the connector 1 and the plug connector 2 are mated together.

For example, In the illustrated embodiment of FIG. 5B, the housing 15 of the receptacle connector 1 has openings 151 configured to engage with complementary latching elements 231 of the plug connector 2. The latching elements 231 may be attached to a projection 23 (e.g., an abutting wall, discussed below) of the plug connector 2, enabling the openings 151 and the latching elements 231 to engage closer to the PCB on which the receptacle connector 1 is mounted, in comparison with conventional arrangements where plug connectors do not have such projections. A height of the receptacle and plug connectors after mating, measured normal to the surface of the PCB on which the receptacle connector 1 is mounted, may therefore be smaller than conventional arrangements, thus enabling a lower profile and more compact electrical connection between the plug and receptacle connectors 2, 1.

According to some embodiments of the present invention, when the housing 15 and the insulative body 11 are assembled together, an inner face of the rear sidewall 15A of the housing 14 may be separated from a rear outer surface 11A of the insulative body 11 such that a gap 153 is present, as shown in FIGS. 1A and 4. That is, an area encircled by the assembly space 150 may be greater than an area taken up by the insulative body 11 in the assembly space, thus resulting in the gap 153. In some embodiments, the gap 153 may be an abutting groove 153 configured to receive a corresponding structure of a mating connector.

According to some embodiments of the present invention, the connector 1 may be mated with the plug connector 2 shown in FIGS. 5A and 5B. In some embodiments, the plug connector 2 may be configured for terminating a cable, to connect the cable to the connector 1. The cable may extend into an interior of the plug connector 2 through a cable opening 22. In some embodiments, conductors of the cable may be attached to terminals in the interior of the plug connector 2. For simplicity of illustration, the cable is not show in FIGS. 5A and 5B.

According to some embodiments of the present invention, the connector 1 may be configured to align with the plug connector 2, such that a terminal board 21 of the plug connector 2 may be received in the accommodation space 111 of the connector 1, and such that an abutting wall 23 of the plug connector 2 may be received in the abutting groove 153 of the connector 1, as shown by the dashed arrows in FIGS. 5A and 5B. In some embodiments, the terminal board 21 may be implemented as a paddle card comprised of a plurality of contact pads (not shown) on one or more surfaces. The contact pads may act as terminals for mating with the terminals 13a of the connector 1. For example, when the plug connector 2 is mated with the connector 1, the terminal board 21 may extend into the accommodation space 111 such that the terminals of the plug connector 2 may be electrically connected to upper ends of the terminals 13a of the connector 1 so as to exchange signals with each other. In some embodiments, lower ends of the terminals 13a may extend beyond a bottom end of the insulative body 11 and may be configured for electrical and mechanical attachment to a PCB. For example, the terminals 13a may be configured for surface-mount soldering to a PCB, although other attachment techniques may be employed instead.

According to some embodiments of the present invention, the accommodation space 111 and the abutting groove 153 of the connector 1 may be elongated in a width direction X (FIG. 1A) and may extend parallel to each other such that, in a mating operation between the plug connector 2 and the connector 1, the plug connector 2 may be pressed down towards the connector 1 while the terminal board 21 and the abutting wall 23 of the plug connector 2 are aligned with the accommodation space 111 and the abutting groove 153 of the connector 1, respectively. A distance D may separate the terminal board 21 and the abutting wall 23, as depicted in FIG. 5A. In some embodiments, D may be measured from a midplane of the terminal board 21 to a midplane of the abutting wall 23.

According to some embodiments of the present invention, the abutting wall 23 of the plug connector 2 may provide a place for attachment of latching components that engage with latching components on the connector 1. In some embodiments, the abutting wall 23 of the plug connector 2 may be comprised of snap-fit protrusions 231, which may be configured to fit within the snap-fit structures 151 of the housing 15 when the plug connector 2 and the connector 1 are mated together, as discussed above. For example, the snap-fit protrusions 231 may be projecting blocks 231 that protrude from an outer surface of the abutting wall 23, and the snap-fit structures 151 may be snap-fit holes 151 configured to receive the projecting blocks 231 therein when the plug connector 2 and the connector 1 are mated together. In some embodiments, the projecting blocks 231 may be formed on a springy member 230 mounted to the abutting wall 23. That springy member 230 may, for example, be a sheet of metal that is bent or otherwise formed to have a portion that is attached to the abutting wall 23 and a portion that stands away from a surface of the abutting wall 23. The projecting blocks 231 may be formed on the portion of the springy member 230 that stands away from the surface of the abutting wall 23. During mating of the plug connector 2 to the connector 1, the springy member 230 may flex inward toward the abutting wall 23 as the plug connector 2 is pressed downward, and the springy member 230 may spring outward when the projecting blocks 231 snap into the into the snap-fit holes 151. Upper edges of the projecting blocks 231 may be configured to engage with and abut against upper edges of the snap-fit holes 151 to prevent unintentional unmating or decoupling of the plug connector 2 from the connector 1. Optionally, the springy member 230 may be comprised of a release tab 232, which may be pressed by a user to force the springy member 230 with the projecting blocks 231 towards the surface of abutting wall 23, to cause the projecting blocks 231 to disengage from the snap-fit holes 151 and thereby enable the plug connector 2 to be pulled upwards and away from the connector 1 in an unmating operation.

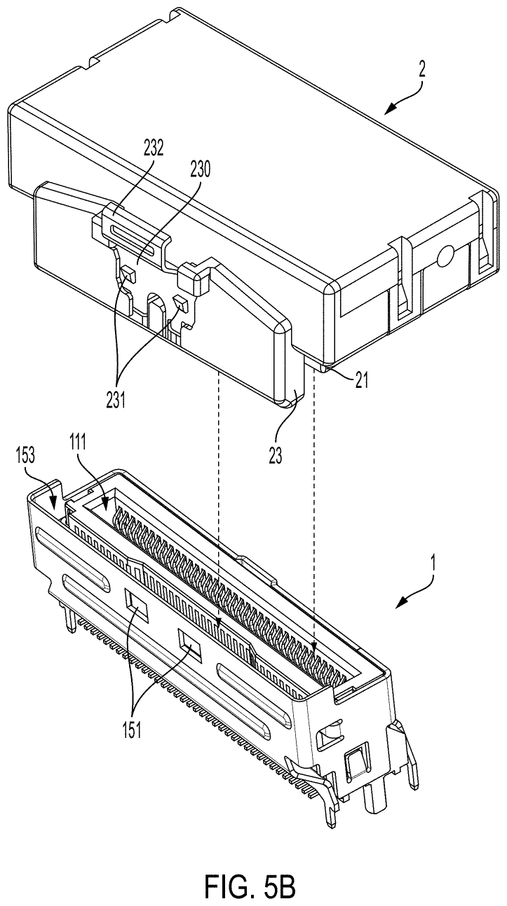

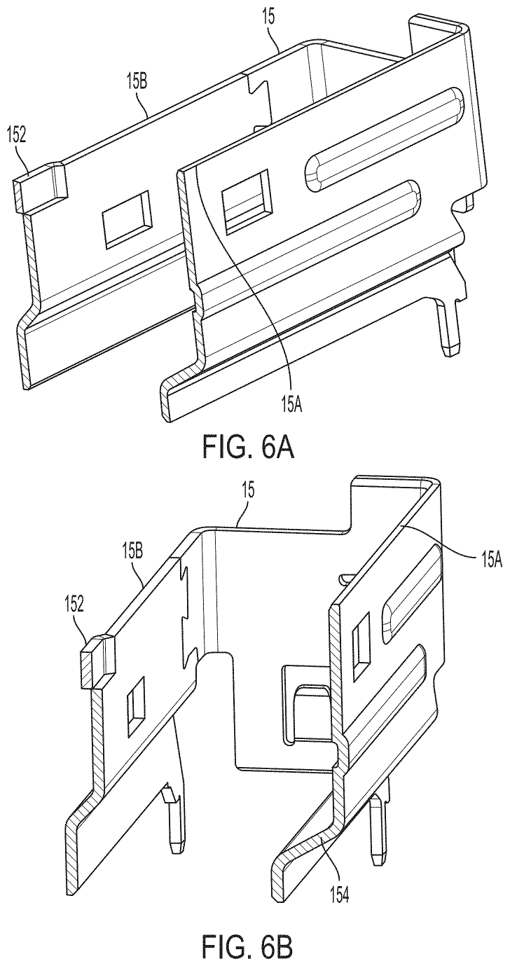

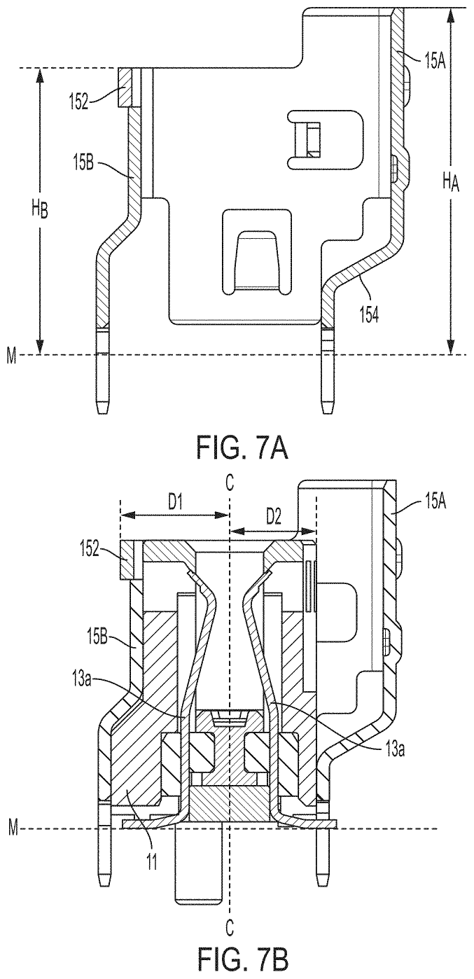

FIGS. 6A and 6B show top perspective views of a cross-section of the housing 15 and the connector 1, respectively, cut along line A-A in FIG. 4. FIG. 7A is an elevational view of the cross section of the housing 15, and FIG. 7B is an elevational view of a cross section of the connector 1, cut along line A-A. According to some embodiments of the present invention, the housing 15 may be comprised of a projection 152 extending outward from the front sidewall 15B. Referring to FIGS. 4 and 7B, a distance D1 from a midplane C of the insulative body 11 to an outer surface of the projection 152 on the front sidewall 15B of the housing 15 may be greater than a distance D2 from the midplane C to the rear outer surface 11A of the insulative body 11. In some embodiments, the distance D separating the terminal board 21 and the abutting wall 23 of the plug connector 2 (FIG. 5A) may be less than the distance D1 but greater than D2, such that the terminal board 21 may be inserted in the accommodation space 111 of the insulative body 11 when properly oriented and such that the terminal board 21 is prevented from being erroneously inserted in the accommodation space 111 in a reverse orientation (i.e., rotated by 180° from a proper orientation). For example, the connector 1 may be compact in size (e.g., less than 1 cm in width) and may be located in a hard-to-reach portion of a PCB installed in a system, such that user may need to perform a blind mating operation where the user may not be able to see the connector 1 when performing a mating operation with the plug connector 2. In such a blind mating operation, the user may be able to differentiate by touch a long dimension (e.g., the width direction X) of the connector 1 but may not be able to differentiate with certainty the front sidewall 15B from the rear sidewall 15A. The presence of the projection 152 on the front sidewall 15B of the housing 15 may enable the user to differentiate the front sidewall 15B by touch and, even if such differentiation may not be made with certainty, the presence of the projection 152 may result in the distance D1 being too large to permit the terminal board 21 of the plug connector 2 from being inserted in the accommodation space 111 of the insulative body 11 in the reverse orientation, because the presence of the abutting wall 23 at the distance D<D1 would prevent the erroneous insertion.

According to some embodiments of the present invention, the housing 15 may be formed of a metal plate and the projection 152 may be formed by bending or crimping the metal plate such that an external surface of the projection 152 extends outward from external surfaces of regions of the front side wall 15B adjacent the projection 152, as depicted in FIGS. 6A to 7B. Alternatively, in some embodiments, the housing 15 may be formed of a metal plate and the projection 152 may be formed by attaching a bump or other protruding structure to an external surface of the front sidewall 15B (e.g., by soldering or brazing or welding a metal bump to the front sidewall 15B). As will be appreciated, the projection 152 may be formed by other techniques not described herein, provided that the projection results in D1>D2, as discussed above. Additionally, although the projection 152 is shown in the drawings to be located at an upper region of the front side wall 15B, in some embodiments the projection 152 may extend further down the front sidewall 15b and may, in some implementations, extend an entirety of a vertical height of the front sidewall 15B. Further, although only a single, centrally positioned projection 152 is shown in the drawings, in some embodiments the front sidewall 15B may be provided with more than one projection 152.

According to some embodiments of the present invention, the plug connector 2 may be configured such that the abutting wall 23 may have a length that is greater than a length of the terminal board 21. This configuration may be used advantageously to enable the abutting wall 23 to align with the abutting groove 153 of the connector 1 prior to the plug connector 2 being pressed downwards in a mating operation, to protect the terminals on the terminal board 21 from coming into contact with another surface until the plug connector 2 and the connector 1 are properly aligned with each other.

According to some embodiments of the present invention, a height H_{A} of the rear sidewall 15A relative to a mounting plane M of the connector 1 may be greater than a height H_{B} of the front sidewall 15B relative to the mounting plane M, such that a portion of the rear sidewall 15A may be higher than a remainder of the connector 1. The mounting plane M may be an imaginary plane at which a PCB may be located when the terminals 13a of the connector 1 are electrically attached or mounted (e.g., soldered) to the PCB. Such a difference in height may be used as an indicator to a user of the front and rear sides of the connector 1. In some embodiments, the portion of the rear sidewall 15A that is higher than the remainder of the connector 1 may be used as a guide for the abutting wall 23 of the plug connector 2 during a mating operation with the connector 1. For example, during a mating operation, the abutting wall 23 may come into contact with an inner surface of the rear sidewall 15A and slide downward into the abutting groove 153 along the inner surface of the rear sidewall 15A. Further, portions of the left sidewall 15C and the right sidewall 15D of the housing 15 adjacent to the rear sidewall 15A may have a height greater than the height H_{B} of the front sidewall 15B and may be equal to the height H_{A} of the rear sidewall 15A. Thus, the rear sidewall 15A and the adjacent portions of the left and right sidewalls 15C, 15D may be used to guide the abutting wall 23 of the plug connector 2 during a mating operation.

According to some embodiments of the present invention, a lower portion of the rear sidewall 15A may form a bearing part 154 configured to limit an insertion distance of the abutting wall 23 of the plug connector 2 into the abutting groove 153 of the connector 1. In some embodiments, the bearing part 154 may be comprised of a bend in the lower portion of the rear side wall 15A. During a mating operation, the abutting wall 23 may extend into the abutting groove 153 until a bottom face of the abutting wall 23 abuts against the bearing part 154. When the abutting wall 23 abuts the bearing part 154, a user performing the mating operation may receive tactile feedback indicating that the plug connector 2 has reached a fully inserted position in the connector 1. In some embodiments, additional force applied by the user after abutment may be exerted on and absorbed by the bearing part 154, thus preventing damage to the terminals 13a of the connector 1 caused by the additional force. Additionally, in some embodiments, by limiting the insertion distance of the abutting wall 23, an insertion distance of the terminal board 21 of the plug connector 2 into the accommodating space 111 of the insulative body 11 of the connector 1 also may be limited, thus preventing terminals on the terminal board 21 from experiencing unnecessary and possibly damaging force during a mating operation. In some embodiments, the rear sidewall 15A, the bearing part 154, and the rear pins 155 of the housing 15 may be formed integrally with each other and may be separated by bends. For example, the housing 15 may be formed of a metal plate that is bent to form the rear sidewall 15A, the bearing part 154, and the rear pins 155.

According to some embodiments of the present invention, the projecting blocks 231 of the plug connector may be located partially or totally below the top surface 116 of the connector 1 when the plug connector 2 and the connector are mated together. Similarly, the snap-fit holes 151 may be located partially or totally below the top surface 116 of the connector 1. By having the connectors 1, 2 latch together at a relatively low height at or below the top surface 116 of the connector (e.g., relatively close to the PCB on which the connector 1 is mounted), the mated connectors 1, 2 may enable a low-profile yet robust electrical connection that is less susceptible of being tilted relative to the PCB. In addition, a width of the connector 1 in the X direction may be made small. The width may, for example, be less than 8 mm (e.g., between 6 mm and 7 mm). In some embodiments, the insulative body 11 may have a recess 112 along a portion of the rear outer surface, as shown in FIGS. 2A and 4. The recess 112 may enable reliable mating and unmating operations with reduced stress on the connector 1.

Accordingly, the present disclosure describes a connector that enables a low-profile connection with another connector and that prevents backwards mating with the other connector. The connector may be comprised of a metal housing, an insulative body disposed in the housing, a plurality of metal terminals fixed to the insulative body, an abutting groove between an inner surface of the housing and the insulative body, and a projection extending outwards from an outer surface of the housing. The connector may be characterized in that a wall of the metal housing may be at a distance from a corresponding face of the insulative body to form the abutting groove, and this wall may be provided with at least one snap-fit hole. Where the other connector is plugged in the connector, an abutting wall of the other connector may extend into the abutting groove, and at least one projecting block protruding from an outer side of the abutting wall may be latched to the at least one snap-fit hole. The projection on the outer surface of the housing prevents the other connector from being plugged in the connector in a reverse orientation.

The disclosed technology is not limited in its application to the details of construction and the arrangement of components set forth in the descriptions herein or illustrated in the drawings. The disclosed technology is capable of other embodiments and of being practiced or of being carried out in various ways not specifically described. Also, the phraseology and terminology used herein is for the purpose of description and should not be regarded as limiting. The use of “including,” “comprising,” “having,” “containing,” or “involving,” and variations thereof herein, is meant to encompass the items listed thereafter and equivalents thereof as well as additional items.

Having thus described at least one illustrative embodiment of the invention, various alterations, modifications and improvements will readily occur to those skilled in the art. The foregoing description is by way of example only and is not intended to be limiting. The present invention is limited only as defined in the following claims and the equivalents thereto.

What is claimed is:

1. A receptacle connector, comprising:
a metal housing comprised of first, second, third, and fourth walls bounding an assembly space; and
an insulative body disposed in a portion of the assembly space and fixed to the metal housing, wherein:
opposite ends of the first wall of the metal housing are attached to first ends of the second and third walls of the metal housing, respectively, and opposite ends of the fourth wall of the metal housing are attached to second ends of the second and third walls of the metal housing, respectively,
the first wall of the metal housing is positioned at a distance from a corresponding first side face of the insulative body to form an abutting groove bounded by the first side face of the insulative body and internal surfaces of the first, second, and third wall of the metal housing,
the fourth wall of the metal housing is positioned adjacent a corresponding second side face of the insulative body,
an external surface of the fourth wall of the metal housing is comprised of a projection that extends outward from the external surface,
the insulative body is comprised of an accommodation space configured to receive a terminal portion of a plug connector when the plug connector is mated with the receptacle connector,
the abutting groove is configured to receive an abutting wall of the plug connector when the plug connector is mated with the receptacle connector,
the projection of the metal housing is configured such that the terminal portion of the plug connector is insertable in the accommodation space of the insulative body when the plug connector positioned in a first orientation and is not insertable in the accommodation space when the plug connector is positioned in a second orientation reverse from the first orientation, and
a perpendicular distance D1 from a centerline of the accommodation space of the insulative body to an outer surface of the projection of the metal housing is greater than a perpendicular distance D2 from the centerline of the accommodation space of the insulative body to the first side face of the insulative body.

2. The receptacle connector of claim 1, wherein the projection is comprised of a bent portion of the fourth wall of the metal housing.

3. The receptacle connector of claim 1, wherein the projection is comprised of a structure fixedly attached to the external surface of the fourth wall of the metal housing.

4. The receptacle connector of claim 1, wherein a bottom portion of the abutting groove limits an insertion depth of the abutting wall of the plug connector into the abutting groove when the plug connector is mated with the receptacle connector.

5. The receptacle connector of claim 4, wherein the bottom portion of the abutting groove is comprised of a bearing section of the metal housing.

6. The receptacle connector of claim 5, wherein the bearing section of the metal housing extends from the first wall of the metal housing.

7. The receptacle connector of claim 1, wherein a height of the first wall of the metal housing is greater than a height of the fourth wall of the metal housing.

8. The receptacle connector of claim 7, wherein a height of the insulative body is same as the height of the fourth wall of the metal housing.

9. The receptacle connector of claim 7, wherein a portion of each of the second and third walls of the metal housing has a height same as the height of the first wall of the metal housing.

10. The receptacle connector of claim 1, wherein the first wall of the metal housing is comprised of at least one snap-fit structure configured to latch with at least one corresponding snap-fit structure on the abutting wall of the plug connector, when the plug connector is mated with the receptacle connector.

11. The receptacle connector of claim 10, wherein a height of the at least one snap-fit structure of the metal housing is lower than a height of a top surface of the insulative body.

12. The receptacle connector of claim 1, wherein:
the accommodation space in the insulative body is elongated in a width direction of the receptacle connector, and
a maximum dimension of the metal housing in the width direction is in a range of 6 mm to 8 mm.

13. The receptacle connector of claim 1, further comprising:
a plurality of metal terminals embedded in the insulative body, wherein the metal terminals are comprised of:
upper ends exposed in the accommodation space and configured to contact the terminal portion of the plug connector, and
lower ends extending from a bottom side of the insulative body and configured for mounting to a printed circuit board.
